(19) United States
(12) Patent Application Publication
(10) Pub. No.: US 2007/0167568 A1
(43) Pub. Date: Jul. 19, 2007

(54) Tie based on grafted polyethylene and on high-impact or crystal polystyrene with cohesive failure

(76) Inventors: Arnaud Gerbaulet, Evreux (FR); Fabrice Chopinez, Evreux (FR); Alain Bouilloux, Saint-Leger de Rotes (FR)

Correspondence Address: Thomas F. Roland, Esq.;Arkema, Inc., 2000 Market St., Philadelphia, PA, 19103, US

(21) Appl. No.: 11/642,079

(22) Filed: Dec. 20, 2006

Related U.S. Application Data
(60) Provisional application No. 60/777,059, filed on Feb. 27, 2006.

(30) Foreign Application Priority Data
Jan. 16, 2006 (FR) 06.00364

(51) Int. Cl. C08L 51/00; C08L 23/04

(52) U.S. Cl. 525/70; 525/240

(57) ABSTRACT

The invention relates to a tie comprising a blend of grafted polyethylene (PE), of grafted or ungrafted high-impact or crystal polystyrene and optionally of ungrafted PE. The grafted PE is preferably composed of two different cografted PEs. This tie is of use in the manufacture of multilayer structures intended for the field of Civil Engineering Works (CEW), more particularly for the fields of aluminium panels, of multilayer pipes, but also for the field of packaging.

This application claims benefit under U.S.C. §119(a) of French Application Number 06.00364, filed Jan. 16, 2006; and also claims benefit under U.S.C. §119(e) of U.S. provisional application 60/777059, filed Feb. 27, 2006.

### FIELD OF THE INVENTION

The invention relates to a tie comprising a blend of grafted polyethylene (abbreviated to PE), of grafted or ungrafted high-impact or crystal polystyrene (abbreviated to PS) and optionally of ungrafted PE. The grafted PE is preferably composed of two different cografted PEs. This tie is of use in the manufacture of multilayer structures intended for the field of Civil Engineering Works (CEW), more particularly for the fields of aluminium panels, of multilayer pipes, but also for the field of packaging.

### BACKGROUND OF THE INVENTION

The document U.S. Pat. No. 6,855,432 relates to a composition essentially composed of:

a) 20 to 60 parts by weight of polyethylene;

b) 10 to 30 parts by weight of polyethylene grafted with maleic anhydride;

c) 10 to 25 parts by weight of high-impact polystyrene (abbreviated to HIPS); and

d) 10 to 25 parts by weight of ethylene-propylene-diene (abbreviated to EPDM).

This tie is used in multilayer structures for tying a layer of metal substrate to a layer of polymer.

The document U.S. Pat. No. 7,074,492 relates to a coextrusion tie comprising:
a) 10 to 35% by weight of a polymer (A) itself composed of a PE blend (from 80 to 20% by weight of PE obtained by metallocene catalysis (A1) and from 20 to 80% by weight of a nonmetallocene LLDPE polyethylene (A2), the blend (A1) and (A2) being cografted with a grafting monomer);
b) 40 to 60% by weight of an SBS block copolymer;
c) 20 to 35% by weight of LLDPE or PE obtained by metallocene catalysis.

The technical problem consists in benefiting from a tie which, in multiplayer structures, is stable over time after ageing in water and which exhibits high peel strengths with cohesive failure. The invention makes it possible to respond to this technical problem.

The tie according to the invention comprises, with the exclusion of an elastomer:
from 10 to 79%, advantageously from 15% to 70%, more advantageously still from 10% to 60% by weight, relative to the total weight of tie, of a PE (A) or of a blend of at least two PEs, PE(A1) and PE(A2), the said blend in turn comprising from 95 to 5% by weight of PE (A1) relative to the weight of PE(A1)+PE(A2), and from 5 to 95% by weight of PE(A2) relative to the weight of PE(A1)+PE(A2), where PE(A1) is different from PE(A2) and where PE(A) is grafted or where the blend PE(A1)+PE(A2) is grafted or co-grafted;
from 21 to 50% by weight, relative to the total weight of tie, of a grafted or ungrafted high-impact PS(B) or of a grafted or ungrafted crystal PS(B), advantageously from 21 to 30%, more advantageously still from 25 to 30%;
from 0 to 70% of an ungrafted PE (C), advantageously from 0 to 60%;
   it being known that the PE (A) or the blend of PE(A1)+(PE(A2) and optionally the PS (B) are either each grafted separately or are then cografted all together during the same grafting stage and that PE (A) is different from PE (C).

A subject-matter of the invention is thus a tie comprising, with the exclusion of an elastomer (% by total weight of the said tie):
from 10 to 79% of a PE (A) which is a VLDPE with a density of between 0.870 and 0.910 g/cm³ or of a blend of at least two polyethylenes, PE (A1) and PE(A2), where:
PE (A2), which is a VLDPE with a density of between 0.870 and 0.910 g/cm³, is different from PE (A1),
PE (A) is grafted or the blend PE (A1) and (A2) is grafted or co-grafted,
PE(A), PE(A1) or PE(A2) are chosen from PE homopolymers and copolymers with, in that case, at least 51% of ethylene and, as comonomer, an alpha-olefin chosen from propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene, 1-triacontene and mixtures thereof,
from 21 to 50% of a grafted or ungrafted high-impact PS (B) or a grafted or ungrafted crystal PS (B),
from 0 to 70% of an ungrafted PE(C) obtained by Ziegler-Natta catalysis. According to one embodiment, the tie is characterized in that it comprises:
15-70% of a PE (A) or of a blend of at least two polyethylenes, PE (A1) and PE(A2),
21-30% of a grafted or ungrafted crystal or high-impact PS (B),
0-60% of an ungrafted PE(C) obtained by Ziegler-Natta catalysis.

According to one embodiment, the tie is characterized in that the PE (A1) is chosen from LLDPE, LDPE and PEm.

According to one embodiment, the tie is characterized in that the PE (C) is an LLDPE with a density of between 0.910 and 0.935 g/cm³.

According to one embodiment, the tie is characterized in that the grafted polymers are grafted with maleic anhydride as grafting monomer.

According to one embodiment, the tie is characterized in that the amount of grafting monomer is from 0.01 to 10% by weight of grafted polymer.

Another subject-matter of the invention is the use of the tie in multilayer structures comprising: aluminium layer/tie layer/PE layer.

According to one embodiment, the use is characterized in that the PE layer is an LDPE layer.

According to one embodiment, the use is characterized in that the PE layer comprises flame-retardant fillers.

The PE(A) is either a very-low-density polyethylene (VLDPE) or a blend comprising at least one VLDPE, PE(A) in that case then being a blend of at least two PEs, PE(A1) and PE(A2), PE(A2) in the said blend being a VLDPE, and PE(A1) being other than a VLDPE. The VLDPE has a density of between 0.870 and 0.910 g/cm³.

With reference to the polyethylene (A) or to the blend of at least two PEs, PE(A1) and PE(A2), the term “polyethylene” refers to homopolymers or copolymers, with the proviso that the ethylene copolymer comprises at least 51% and preferably 75% (on a molar basis) of ethylene.

Mention may be made, as comonomers, of α-olefins, advantageously those having from 3 to 30 carbon atoms; mention may be made, as examples of α-olefins, of propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, 1-docosene, 1-tetracosene, 1-hexacosene, 1-octacosene and 1-triacontene. These α-olefins can be used alone or as a mixture of two or of more than two.

The following compounds are excluded from the polyethylene (A) or from the blend of at least two PEs, PE(A1) and PE(A2):

esters of unsaturated carboxylic acids, such as, for example, alkyl (meth)acrylates, it being possible for the alkyls to have up to 24 carbon atoms; examples of alkyl acrylate or methacrylate are in particular methyl methacrylate, ethyl acrylate, n-butyl acrylate, isobutyl acrylate or 2-ethylhexyl acrylate,

vinyl esters of saturated carboxylic acids, such as, for example, vinyl acetate or propionate,

dienes, such as, for example, 1,4-hexadiene.

The MFI (viscosity index at 190° C., 2.16 kg) of the polyethylene (A) or of the blend of at least two PEs, PE(A1) and PE(A2), is advantageously between 0.1 and 1000 g/10 min.

Mention may be made, as examples of polyethylenes PE(A1), of:
low density polyethylene (LDPE);
linear low density polyethylene (LLDPE);
polyethylene obtained by metallocene catalysis (PEm), that is to say the polymers obtained by copolymerization of ethylene and of α-olefin, such as propylene, butene, hexene or octene, in the presence of a single-site catalyst generally composed of a zirconium or titanium atom and of two cyclic alkyl molecules bonded to the metal. More specifically, the metallocene catalysts are usually composed of two cyclopentadiene rings bonded to the metal. These catalysts are frequently used with aluminoxanes as cocatalysts or activators, preferably methylaluminoxane (MAO). Hafnium can also be used as metal to which the cyclopentadiene is attached. Other metallocenes can include transition metals from Groups IVA, VA and VIA. Metals from the lanthanide series can also be used.

Preferably, (A) is a blend of PE (A1) and PE (A2), PE (A1) being different from PE (A2).

This is a blend of PE(A1), with a density of between 0.910 and 0.935 g/cm³, and of PE(A2), with a density of between 0.870 and 0.910 g/cm³. Advantageously, PE(A1) is an LLDPE and PE(A2) is a VLDPE.

The ungrafted polyethylene (C) is understood to mean a homopolymeric or copolymeric polyethylene obtained by Ziegler-Natta catalysis. PEs obtained by metallocene catalysis are excluded.

Mention may be made, as comonomers, of:

α-olefins, advantageously those having from 3 to 30 carbon atoms; mention may be made, as examples of α-olefins, of propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, 1-docosene, 1-tetracosene, 1-hexacosene, 1-octacosene and 1-triacontene; these α-olefins can be used alone or as a mixture of two or of more than two,

esters of unsaturated carboxylic acids, such as, for example, alkyl (meth)acrylates, it being possible for the alkyls to have up to 24 carbon atoms; examples of alkyl acrylate or methacrylate are in particular methyl methacrylate, ethyl acrylate, n-butyl acrylate, isobutyl acrylate or 2-ethylhexyl acrylate, and ethylene/alkyl (meth)acrylate copolymers possibly containing up to 60% by weight of alkyl (meth)acrylate and preferably from 2 to 40%,

vinyl esters of saturated carboxylic acids, such as, for example, vinyl acetate or propionate,

dienes, such as, for example, 1,4-hexadiene.

The polyethylene can comprise several of the above comonomers.

Advantageously, the ethylene copolymer comprises at least 51% and preferably 75% (as moles) of ethylene. Its density can be between 0.86 and 0.98 g/cm³. Its MFI (viscosity index at 190° C., 2.16 kg) is advantageously between 0.1 and 1000 g/10 min.

Mention may be made, as examples of polyethylenes, of:

low density polyethylene (LDPE);

linear low density polyethylene (LLDPE);

very low density polyethylene (VLDPE).

It is preferably LLDPE.

As regards the polystyrene (B), it is a high-impact polystyrene, abbreviated to HIPS, or a crystal polystyrene. Styrene elastomers are excluded. HIPSs have a melt flow index, measured according to ASTM D-1238, condition G (200° C., 5000 g), from approximately 0.5 to 12 g/10 min, advantageously between 1 and 6 g/10 min, preferably between 2 and 4 g/10 min, and a density from 1.04 to 1.05.

These are, for example, the PSs sold by Dow under the references Styron 457 and 484 (high-impact PS) or under the references Styron 634 and 637 (crystal PS) or the PSs sold by Total Petrochemical® under the references 8350, 7240, 4241 and 3450 (high-impact PS) or under the references 1160, 1340 and 1450N (crystal PS).

It would not be departing from the scope of the invention to use a high-impact PS grafted beforehand or a crystal PS grafted beforehand. It would also be possible to consider a “one-pot” cografting of PE(A1)+PE(A2)+PS(B), in other words a simultaneous grafting operation in a single step.

The grafting monomer is an unsaturated carboxylic acid. It would not be departing from the scope of the invention to use a functional derivative of this acid.

Examples of unsaturated carboxylic acids are those having 2 to 20 carbon atoms, such as acrylic, methacrylic, maleic, fumaric and itaconic acids. The functional derivatives of these acids comprise, for example, the anhydrides, the ester derivatives, the amide derivatives, the imide derivatives and the metal salts (such as the alkali metal salts) of the unsaturated carboxylic acids.

Unsaturated dicarboxylic acids having 4 to 10 carbon atoms and their functional derivatives, particularly their anhydrides, are particularly preferred grafting monomers.

These grafting monomers comprise, for example, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-2,3-dicarboxylic and x-methylbicyclo[2.2.1]hept-5-ene-2,3-dicarboxylic acids and maleic, itaconic, citraconic, allylsuccinic, cyclohex-4-ene-1,2-dicarboxylic, 4-methylenecyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydrides.

Examples of other grafting monomers comprise C₁-C₈ alkyl esters or glycidyl ester derivatives of unsaturated carboxylic acids, such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate and diethyl itaconate; the amide derivatives of unsaturated carboxylic acids, such as acrylamide, methacrylamide, maleic monoamide, maleic diamide, maleic N-monoethylamide, maleic N,N-diethylamide, maleic N-monobutylamide, maleic N,N-dibutylamide, fumaric monoamide, fumaric diamide, fumaric N-monoethylamide, fumaric N,N-diethylamide, fumaric N-monobutylamide and fumaric N,N-dibutylamide; the imide derivatives of unsaturated carboxylic acids, such as maleimide, N-butylmaleimide and N-phenylmaleimide; and metal salts of unsaturated carboxylic acids, such as sodium acrylate, sodium methacrylate, potassium acrylate and potassium methacrylate.

Preference is given to maleic anhydride (abbreviated to MAH).

Various known processes can be used to graft a grafting monomer.

The grafting reaction is carried out in a single- or twin-screw extruder fed with polyolefins in a feed hopper, for example in the form of granules. In a first region of the extruder, the polyolefins are melted by heating and, in a second region, the reactants are introduced into the molten mass of the polyolefins.

For example, the grafting can be carried out by heating the polymer to be grafted at high temperature, approximately 150° C. to approximately 300° C., in the presence or in the absence of a solvent, with or without radical initiator. Appropriate solvents which can be used in this reaction are benzene, toluene, xylene, chlorobenzene or cumene, inter alia.

It is preferable for the region for introduction of the reactants to be sufficiently long and at a temperature sufficiently low to ensure good dispersion of the reactants and the least possible thermal decomposition of the radical initiator.

The grafting reaction proper takes place in a third region of the extruder at a temperature capable of ensuring the complete decomposition of the radical initiator. Before the departure of the molten mass at the extruder head, a venting region is provided where the products from the decomposition of the initiator and the unreacted grafting monomer are vented, for example under vacuum.

The grafted polyolefins are recovered at the outlet of the extruder, for example in the form of granulated laces, after cooling under cold air.

The (graft)/(grafted polymer) ratio by weight is generally between 0.1 and 5 and preferably 0.15 and 2.5.

The radical initiators can be chosen from peroxides, peracids, peresters or peracetals. They are generally used in a proportion of 0.01% to 0.5% by weight, with respect to the polyolefins to be grafted. Appropriate radical initiators which can be used comprise t-butyl hydroperoxide, cumene hydroperoxide, diisopropylbenzene hydroperoxide, di(t-butyl) peroxide, t-butyl cumyl peroxide, dicumyl peroxide (DICUP), 1,3-bis(t-butylperoxyisopropyl)benzene, acetyl peroxide, benzoyl peroxide, isobutyryl peroxide, bis(3,5,5-trimethylhexanoyl) peroxide, methyl ethyl ketone peroxide, 2,5-dimethyl-2,5-di(tert-butylperoxy)hexane (DHBP) and α, α′-di(tert-butylperoxy)diisopropylbenzene (Y1490).

It is preferable to dissolve the radical initiator in the grafting monomer in the liquid state before introducing it, for example by means of a metering pump, into the polyolefins in the molten state.

The amount of the grafted monomer is determined by quantitative determination of the succinic functional groups by FTIR spectroscopy.

The amount of the grafting monomer in the polymer modified by grafting obtained in the abovementioned way can be appropriately chosen but it is preferably from 0.01 to 10% by weight, better still from 0.5 to 2% by weight, with respect to the weight of grafted polymer.

The melt flow index (MFI) of the grafted thermoplastic polymer is between 0.1 and 15 g/10 min (measured at 190° C. under 2.16 kg), advantageously between 0.4 and 5 g/10 min. The melting point is between 80 and 130° C.

Examples of the invention will now be given. The compositions of the examples and of the comparative examples are given in Table 1.

TABLE 1

| Tie | | Comparative Example 1 | | Example 2 | | Example 3 | | Comparative Example 4 | |
|---|---|---|---|---|---|---|---|---|---|
| Characteristic | Type of PE | VLDPE | LLDPE | VLDPE | LLDPE | VLDPE | LLDPE | VLDPE | LLDPE |
| of the polymer | Density (g/cm³) | 0.87 | 0.92 | 0.87 | 0.92 | 0.87 | 0.92 | 0.87 | 0.92 |
| (A) | Comonomer | 1-octene | 1-butene | 1-octene | 1-butene | 1-octene | 1-butene | 1-octene | 1-butene |
| | Composition (%)** | 30% | 70% | 30% | 70% | 30% | 70% | 30% | 70% |

| | Degree of grafting | 0.90% | 0.90% | 0.90% | 0.90% |
|---|---|---|---|---|---|
| | (%)*** | | | | |
| | Grafting monomer | MAH | MAH | MAH | MAH |
| | MFI (g/10 min), | 0.7 | 0.7 | 0.7 | 0.7 |
| | 190° C. - 2.16 kg | | | | |
| Proportion of A (%)**** | | 15% | 15% | 15% | 15% |
| Characteristic | Type of PS | | High-impact PS | Crystal PS | High-impact PS |
| of the polymer | Density (g/cm³) | | 1.04 | 1.05 | 1.04 |
| (B) | MFI (g/10 min), | | 4.5 | 4 | 4.5 |
| | 200° C. - 2.16 kg | | | | |
| Proportion of B (%)**** | | | 30% | 30% | 20% |
| Characteristic | Type of PE | LLDPE | LLDPE | LLDPE | LLDPE |
| of the polymer | Density (g/cm³) | 0.91 | 0.91 | 0.91 | 0.91 |
| (C) | Comonomer | C4 | C4 | C4 | C4 |
| | MFI (g/10 min), | 3 | 3 | 3 | 3 |
| | 190° C. - 2.16 kg | | | | |

| | | | | |
|---|---|---|---|---|
| Proportion of C (%)**** | 85% | 55% | 55% | 65% |

| | | | |
|---|---|---|---|
| Tie | Example 5 | Comparative Example 6 | Example 7* |

| | | | | | | |
|---|---|---|---|---|---|---|
| Characteristic | Type of PE | VLDPE | LLDPE | LLDPE | VLDPE | LLDPE |
| of the polymer | Density (g/cm³) | 0.87 | 0.92 | 0.92 | 0.87 | 0.92 |
| (A) | Comonomer | 1-octene | 1-butene | 1-butene | 1-octene | 1-butene |
| | Composition (%)** | 30% | 70% | 100% | 7% | 93% |

| | Degree of grafting | 0.90% | 0.90% | 0.90% |
|---|---|---|---|---|
| | (%)*** | | | |
| | Grafting monomer | MAH | MAH | MAH |
| | MFI (g/10 min), | 0.7 | 0.7 | 0.7 |
| | 190° C. - 2.16 kg | | | |
| Proportion of A (%)**** | | 15% | 15% | 70% |
| Characteristic | Type of PS | High-impact PS | High-impact PS | High-impact PS |
| of the polymer | Density (g/cm³) | 1.04 | 1.04 | 1.04 |
| (B) | MFI (g/10 min), | 4.5 | 4.5 | 4.5 |
| | 200° C. - 2.16 kg | | | |
| Proportion of B (%)**** | | 25% | 30% | 30% |
| Characteristic | Type of PE | LLDPE | LLDPE | |
| of the polymer | Density (g/cm³) | 0.91 | 0.91 | |
| (C) | Comonomer | C4 | C4 | |
| | MFI (g/10 min), | 3 | 3 | |
| | 190° C. - 2.16 kg | | | |

| | | |
|---|---|---|
| Proportion of C (%)**** | 60% | 55% |

*the polymer (A) and the polymer (B) are co-grafted
**% by weight expressed relative to the total weight of polymer (A)
***% by weight of grafted monomer relative to the total weight of grafted polymer
****% expressed relative to the total weight of tie

Samples 1 to 7 are prepared with a structure of Alu (350 μm)/tie (35 μm)/PE (30 μm)/tie (35 μm)/Alu (350 μm) type with, for tie, the compositions of (Comparative) Examples 1 to 7 for the respective Samples 1 to 7 (see Table 1 above).

The process for producing Samples 1 to 7 is as follows:
1) Extrusion of a two-layer film consisting of 35 μm of tie and 15 μm of a low density polyethylene (abbreviated to LDPE) on a Collin® coextrusion machine.
2) Pressing an Alu (350 μm)/tie (35 μm)/PE (30 μm)/tie (35 μm)/Alu (350 μm) structure under 3 MPa at 170° C. for 5 min and then cooling with air. The time is then t0.
3) Measurement of the peel strength at an angle of 180° with a pull rate of 50 mm/min.
4) Evaluation of the type of failure, defined by AF for Adhesive Failure and by CF for Cohesive Failure.

5) Results appended in Table 2.

TABLE 2

| | Sample 1 | Sample 2 | Sample 3 | Sample 4 | Sample 5 | Sample 6 | Sample 7 |
|---|---|---|---|---|---|---|---|
| Peel strength (N/cm) | 30 | 70 | 68 | 70 | 65 | 40 | 72 |
| Type of failure | AF | CF | CF | AF | CF | AF | CF |

Peel strength measurements were then conducted at t0, defined as above, and then under different conditions, indicated below. The measurements are collated in Table 3 below.

TABLE 3

| | Peel Strength (N/cm) | | | |
|---|---|---|---|---|
| | Sample 1 | | | |
| | (with | Sample 2 | Sample 5 | Sample 7 |
| | Comparative | (with | (with | (with |
| | Example 1) | Example 2) | Example 5) | Example 7) |
| t0 | 30 | 70 | 65 | 72 |
| t0 + 11 days | 24 | 76 | 66 | 72 |
| t0 + 8 hours | 15 | 74 | 67 | 74 |
| in boiling water | | | | |
| t0 + 500 hours | 17 | 70 | 66 | 75 |
| in water at | | | | |
| 23° C. | | | | |

It is found that the peel strength is maintained at a satisfactory level after ageing in water with the composition comprising the tie according to the invention.

This formulation allows us to have high adhesion to aluminium with a cohesive aspect to the peeling and to maintain the peel strengths over time and after ageing in water.

What is claimed is:

1. Tie comprising, (% by total weight of the said tie):
from 10 to 79% of a polyethylene (PE) (A) which is a very low density polyethylene (VLDPE) with a density of between 0.870 and 0.910 g/cm³ or of a blend of at least two polyethylenes, PE (A1) and PE(A2), where:
PE (A2), which is a VLDPE with a density of between 0.870 and 0.910 g/cm³, is different from PE (A1),
PE (A) is grafted or the blend PE (A1) and (A2) is grafted or co-grafted,lend
PE(A), PE(A1) or PE(A2) are chosen from PE homopolymers and copolymers, said copolymers comprising at least 51 mole % of ethylene and a comonomer selected from the group consisting of: an alpha-olefin chosen from propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicocene, 1-dococene, 1-tetracocene, 1-hexacocene, 1-octacocene, 1-triacontene and mixtures thereof; and wherein said PE (A) or blend of at least two polyethylenes, PE (A1) and PE(A2) is not selected from the group consisting of esters of unsaturated carboxylic acids, vinylesters of saturated carboxylic acids, and dienes;
from 21 to 50% of a grafted or ungrafted high-impact PS(B) or a grafted or ungrafted crystal PS (B); and
from 0 to 70% of an ungrafted PE(C) obtained by Ziegler-Natta catalysis.

2. Tie according to claim 1, wherein said tie comprises:
15-70% of a PE (A) or of a blend of at least two polyethylenes, PE (A1) and PE(A2);
21-30% of a grafted or ungrafted crystal or high-impact PS (B);
0-60% of an ungrafted PE(C) obtained by Ziegler-Natta catalysis.

3. Tie according to claim 1, wherein the PE (A1) is chosen from a linear low density polyethylene (LLDPE), a low density polyethylene (LDPE) and a metallocene polyethylene (PEm).

4. Tie according to claim 3, wherein PE(A1) is an LLDPE.

5. Tie according to claim 1, wherein the PE (C) is chosen from an LDPE, an LLDPE and a VLDPE.

6. Tie according to claim 5, wherein PE(C) is an LLDPE.

7. Tie according to claim 1, wherein the grafted polymers are grafted with a grafting monomer selected from the group consisting of unsaturated carboxylic acids having 2 to 20 carbon atoms and their derivatives, and unsaturated dicarboxylic acids having 4 to 10 carbon atoms and their derivatives.

8. Tie according to claim 7, wherein the grafting monomer is maleic anhydride.

9. Tie according to claims 7, wherein the amount of grafting monomer is from 0.01 to 10% by weight of grafted polymer.

10. Tie according to claim 1, wherein copolymers comprising PE(A), PE(A1) or PE(A2) comprise at least 75 mole % of ethylene.

11. A multilayer structure comprising aluminium layer/tie layer/PE layer, wherein said tie layer is the tie of claim 1.

12. The multiplayer structure of claim 11, wherein the PE layer is an LDPE layer.

13. The multiplayer structure of claim 11, wherein the PE layer further comprises flame-retardant fillers.
